(19) United States
(12) Patent Application Publication
(10) Pub. No.: US 2008/0307843 A1
(43) Pub. Date: Dec. 18, 2008

(54) Nitrification inhibitor and soil improver and fertilizer containing the same

(75) Inventors: Guntur V. Subbarao, Ibaraki (JP); Kazuhiko Nakahara, Ibaraki (JP); Takayuki Ishikawa, Tochigi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: JAPAN INTERNATIONAL RESEARCH CENTER FOR AGRICULTURAL SCIENCES, Tsukuba-shi (JP)

(21) Appl. No.: 11/898,187

(22) Filed: Sep. 10, 2007

(30) Foreign Application Priority Data
Sep. 11, 2006 (JP) 2006-246082

(51) Int. Cl. C05F 11/00

(52) U.S. Cl. 71/27

(57) ABSTRACT

A nitrification inhibitor and a soil improver and a fertilizer containing the same are offered which can be utilized in a wide area from a tropical to a temperate zone, and can be easily obtained from natural origin materials. It is a nitrification inhibitor to inhibit soil nitrification, containing juglone as a main component. By incorporating this nitrification inhibitor into a soil improver or a fertilizer, nitrification of soil can be effectively inhibited. The nitrification inhibitor is preferably contained in a soil improver or a fertilizer in the range of 20 to 50% weight %.

### FIELD OF THE INVENTION

The present invention relates to a nitrification inhibitor and soil improvers and fertilizers containing the same, which can inhibit nitrification of soil.

### BACKGROUND OF THE INVENTION

The oxidation reaction of ammonia, namely, nitrification caused by the action of soil micro-organisms results in the serious loss of nitrogen fertilizers used for agricultural and horticultural production, and also results the pollution of soil environment. In order to inhibit soil nitrification, mainly such synthetic chemicals have so far been used as nitrapyrin (2-chloro-6-Trichloromethylpyridine) and dicyandiamide (See, for example, Japanese Patent Laid-Open Application H11-278973A (1999)).

Among the synthetic chemicals, nitrapyrin is so highly volatile, mostly ineffective at soil temperatures >20° C., thus, has only limited use in specific production systems such as winter cereals in North America.

On the other hand, dicyandiamide is effective at higher temperature compared with nitrapyrin, but can't bind to the soil, thus susceptible to leaching out from the site of application, thus its effectiveness is limited under field conditions; also dicyandiamide needs to be applied in very high concentrations (about 30% of the fertilizer w/w), and also expensive to use in practical agriculture, thus has not been widely adopted. From such background, the development of economical nitrification inhibition is sought which could be used in the wide area from tropical to temperate zone.

### SUMMARY OF THE INVENTION

In order to inhibit nitrification of soil for agriculture and horticulture, the above-mentioned synthetic chemicals have so far been used, but each of them has its own defect, and there are also problems that their applicable areas and crops are limited.

From said background, no economical nitrification inhibitor has been obtained which is utilizable in wide areas from tropical to temperate zones.

The object of the present invention is, in reference to the above-mentioned problems, to provide a nitrification inhibitor and a soil improver and a fertilizer containing the same, which are utilizable in wide areas from tropical to temperate zones, and can be easily obtained from materials of natural origin.

The present inventors have devoted themselves to the study, searching for nitrification inhibitive substances of plant origin; among various phenolic compounds secreted from plant roots as the main target, and as the result, completed the present invention by confirming that juglone (5-hydroxy-1,4-naphtoquinone) can bring about excellent nitrification inhibitive effect.

In order to attain the above-mentioned object, the nitrification inhibitor in accordance with the present invention is characterized to contain juglone as the main component to inhibit nitrification of soil.

According to the above-mentioned constitution, a nitrification inhibitor to prevent nitrification of soil can be offered at low cost by using juglone which can be obtained at low price by extraction from such portions as seed shells, tree barks, leaves, and roots of various walnut family primarily walnut itself. Since the nitrification inhibitor of the present invention is non-volatile and chemically stable juglone as the main component, it can be applied to wider areas than the conventional nitrification inhibitive substances, and can maintain for long time the nitrification inhibitive effect similar or superior to that of the conventional nitrification inhibitive substances.

The soil improver in accordance with the present invention is characterized by a nitrogen fertilizer such as urea containing nitrification inhibitor consisting of juglone preferably in the range of 20 to 50 weight %.

According to the above-mentioned constitution, a soil improver containing a nitrification inhibitor can be offered at low cost by using juglone which can be obtained at low price by extraction from such portions as seed shells, tree barks, leaves, and roots of various walnut family including primarily walnut itself. Since the soil improver of the present invention contains the nitrification inhibitor consisting of non-volatile and chemically stable juglone, it can be applied to wide areas, and can inhibit for long time the nitrification of nitrogenous components and thereby prevent deterioration of soil environment.

The nitrogen fertilizer (such as urea) in accordance with the present invention is characterized to contain nitrification inhibitor consisting of juglone preferably in the range of 20 to 50 weight %.

According to the above-mentioned constitution, a fertilizer containing a nitrification inhibitor can be offered at low cost by using juglone which can be obtained at low price by extraction from such portions as seed shells, tree barks, leaves, and roots of various walnut family including primarily walnut itself. Since the fertilizer of the present invention contains the nitrification inhibitor consisting of non-volatile and chemically stable juglone, it can be applied to wide areas, and can inhibit for long time the nitrification of nitrogenous components and thereby save fertilizer and prevent deterioration of soil environment.

In accordance with the present invention, the nitrification inhibitor can be obtained at low cost which maintains the effective nitrogenous components in the soil and prevents deterioration of soil environment, and also the fertilizer or the soil improver containing said nitrification inhibitor can be obtained.

### BRIEF DESCRIPTION OF THE DRAWINGS

FIG. 1 is a table showing 50% inhibitory concentration of juglone of Example 1 and phenolic compounds of Comparative Examples 1-9.

FIG. 2 is a table showing 50% inhibitory concentration of juglone of Example 1 and compounds of Comparative Examples 10-13.

FIG. 3 is a table showing the measurement results of nitrate concentration after 30 and 60 days for fertilizers of Examples 2 and 3 and Comparative Examples 16 and 17.

### DETAILED DESCRIPTION OF THE PREFERRED EMBODIMENT

Hereinafter, the embodiments of the present invention are explained in detail, referring to the attached drawings.

Explanation is first made of the nitrification inhibitor of the present invention.

The nitrification inhibitor of the present invention contains juglone (5-hydroxy-1,4-naphtoquinone), a phenolic compound, as the main component, and has a function to inhibit nitrification as the oxidation reaction of ammonia in the soil.

The chemical structure of juglone is shown as Chemical Formula (1) below.

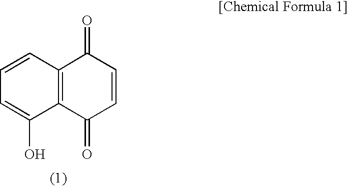

Juglone relating to the above-mentioned nitrification inhibitor is a compound extractable from such portions as seed shells, tree barks, leaves, and roots of various walnut family including primarily walnut itself, and can be obtained at low cost. Also, jugone can be prepared by known methods of chemical synthesis with 1,5-dihydroxynaphthalene or the like as a starting material.

Juglone, in relation to the nitrification inhibitor of the present invention, strongly inhibits nitrification in the test using a nitrification bacteria (Nitrosomonas europaea) which has a nitrification function, as well as in soil tests. Said nitrificiation-inhibitory function shows the effect equal or superior to the conventional nitrificiation-inhibitory substances.

Juglone, in relation to the nitrification inhibitor of the present invention, is non-volatile and chemically stable. Therefore, the nitrification inhibitor of the present invention can be applied to wider areas than the conventional nitrification inhibitive substances, for example, in the wide area from tropical to temperate zones. Also, when the nitrification inhibitor of the present invention is sprayed or mixed to the soil, it can maintain for long time the nitrification inhibitive function in the soil.

Juglone, in relation to the nitrification inhibitor of the present invention, is widely used as a colorant, a dye, and the like, and because of its low toxicity in the ordinarily used range (Database RTECS Online, RTECS No. QJ5775000, Abstract (December 2000)), its safety is extremely high.

Explanation is next made of a soil improver of the present invention.

A soil improver of the present invention is constituted containing a nitrification inhibitor consisting of juglone. The soil improver of the present invention can be constituted containing, in addition to a nitrification inhibitor, such an inorganic material as lime and such fertile soil as black soil. Further, as a soil improver for horticulture, a potting compost containing fertilizers may be prepared. The preferable content of the nitrification inhibitor of the present invention to be added to a soil improver is about 20 to 50 weight ppm. Since 50 weight ppm is sufficient for nitrification inhibition as the content of a nitrification inhibitor, more need not be added. On the other hand, if the content of a nitrification inhibitor is 20 weight ppm or less, it is not preferable because the nitrification inhibitory effect is small.

Since the soil improver of the present invention contains a nitrification inhibitor consisting of non-volatile and chemically stable juglone, nitrification of nitrogenous components can be inhibited, and hence deterioration of soil environment can be prevented for long time. Also, juglone to be used for a nitrification inhibitor can be obtained at low price. Therefore, the soil improver containing the nitrification inhibitor of the present invention can be manufactured at low cost.

Explanation is next made of a fertilizer of the present invention.

A fertilizer of the present invention is constituted containing a nitrification inhibitor consisting of juglone besides a fertilizer itself.

Here, as a fertilizer, inorganic or organic fertilizers may be mentioned, as well as their mixture. As such inorganic fertilizers, such nitrogenous fertilizers as urea, ammonium sulfate, and ammonium chloride, such phosphate fertilizers as calcium perphosphate, and such potassium fertilizers as potassium sulfate, and potassium chloride can be used. Also as organic fertilizers, bone powder, compost, and others can be used. The preferable content of the nitrification inhibitor of the present invention to be added to a fertilizer is about 20 to 50 weight ppm. Since 50 weight ppm is sufficient for nitrification inhibition as the content of a nitrification inhibitor, more needs not be added. On the other hand, if the content of a nitrification inhibitor is 20 weight ppm or less, it is not preferable because the nitrification inhibitory effect is small.

Since the fertilizer of the present invention contains a nitrification inhibitor consisting of non-volatile and chemically stable juglone, together with fertilizer components, nitrification of nitrogenous components can be inhibited, and hence fertilizers can be saved, and deterioration of soil environment can be prevented for a long time. Also, juglone to be used for a nitrification inhibitor can be obtained at low price. Therefore, the fertilizer containing the nitrification inhibitor of the present invention can be manufactured at low cost.

### Example 1

Hereinafter, the present invention is explained in more detail referring to examples.

As a nitrification inhibitor of Example 1, the commercially available juglone, a phenolic compound, was prepared.

### Comparative Example 1

As Comparative Example 1, the commercially available o-coumaric acid, a phenolic compound like juglone, was prepared.

### Comparative Example 2

As Comparative Example 2, the commercially available pyrogallol, a phenolic compound like juglone, was prepared.

### Comparative Example 3

As Comparative Example 3, the commercially available hydroquinone, a phenolic compound like juglone, was prepared.

### Comparative Example 4

As Comparative Example 4, the commercially available quercetin, a phenolic compound like juglone, was prepared.

### Comparative Example 5

As Comparative Example 5, the commercially available resveratrol, a phenolic compound like juglone, was prepared.

### Comparative Example 6

As Comparative Example 6, the commercially available catechol, a phenolic compound like juglone, was prepared.

### Comparative Example 7

As Comparative Example 7, the commercially available ferulic acid, a phenolic compound like juglone, was prepared.

### Comparative Example 8

As Comparative Example 8, the commercially available caffeic acid, a phenolic compound like juglone, was prepared.

### Comparative Example 9

As Comparative Example 9, the commercially available baicalein, a phenolic compound like juglone, was prepared.

### Comparative Example 10

As Comparative Example 10, the commercially available catechin, sinapic acid, gallic acid, salicylic acid, cinnamic acid, 3-phenylpropionic acid, anisic acid, phthalic acid, vanillic acid, ascorbic acid, and ellagic acid were prepared.

### Comparative Example 11

As Comparative Example 11, the commercially available quinic acid, syringic acid, and stilbene were prepared.

### Comparative Example 12

As Comparative Example 12, the commercially available daidzein, p-hydroxybenzoic acid, chlorogenic acid, gentisic acid, protocatechuic acid, coumarine, benzoic acid, fumaric acid, and isovanillic acid were prepared.

### Comparative Example 13

As Comparative Example 13, the commercially available genistein, vanilline, phloroglucine, orcinol, and resorcinol were prepared.

### Comparative Example 14

As Comparative Example 14, the commercially available nitrapyrin, a nitrification inhibitor consisting of a conventional synthetic chemical, was prepared.

### Comparative Example 15)

As Comparative Example 15, the commercially available dicyanodiamide, a nitrification inhibitor consisting of a conventional synthetic chemical, was prepared.

Explanation is next made of the nitrification inhibitory function of juglone of the above-mentioned Example 1, the phenolic compounds of Comparative Examples 1-9, the compounds of Comparative Examples 10-13, and the nitrification inhibitors of Comparative Examples 14 and 15.

Observation was conducted using in-vitro nitrification bacteria. Explanation is first made of preparation of suspension of the nitrification bacteria used for observation.

The nitrification bacteria (Nitrosomonas europaea IF014298. See Iizumi and two others, Appl. Environment. Microbiol., vol. 64, p. 3656-3662, 1998; Plant and Soil, vol. 288, p. 101-112, 2006) with a bacteria-origin luciferase gene (luxAB) introduced therein was aerobically cultivated in P culture media containing 25 mg/1000 cm³ of kanamycin at 30° C. for 7 to 9 days, and after washing, suspended in fresh P culture media, thereby nitrification bacteria suspension was prepared. This nitrification bacteria suspension was kept in the dark place for 30 minutes or longer before experiment.

The composition of P culture media consists of 2.5 g of (NH₄)₂SO₄, 0.7 g of KH₂PO₄, 13.5 g of Na₂HPO₄, 0.5 g of NaHCO₃, 100 mg of MgSO₄-7H₂O, 5 mg of CaCl₂-2H₂O, 1 mg of Fe-EDTA, and 1000 cm³ of water, and its pH was 8.0.

Nitrification function was evaluated by, after mixing in-vitro the aqueous solution of nitrification bacteria suspension consisting of 0.25 cm³ of said, nitrification bacteria suspension and 0.2 cm³ of water, and 0.01 cm³ of the sample solution of each Example and Comparative Example, measuring biological luminescence accompanying nitrification reaction after incubation with the sample solution at 15° C. for 30 minutes using a luminometer (Turner Designs, TD20/20). The biological luminescence accompanying nitrification reaction decreased if a sample solution of each Example and Comparative Example had nitrification-inhibitory substance. Therefore, the luminescence of the case where a sample solution of each Example and Comparative Example was added to the aqueous solution of nitrification bacteria suspension divided by the luminescence of the case of aqueous bacteria suspension without addition of a sample solution of each Example and Comparative Example was defined as nitrification-inhibitory ratio.

Said observation was conducted for the sample solutions of Example 1 and Comparative Examples 1-13 by changing the sample solution concentration. Next, from the result of observation, concentration dependency of nitrification-inhibitory ratio was studied, and from its result evaluation was made for the concentration where the nitrification-inhibitory ratio of each phenolic compounds became 50% (hereinafter, to be properly defined as 50% inhibitory concentration).

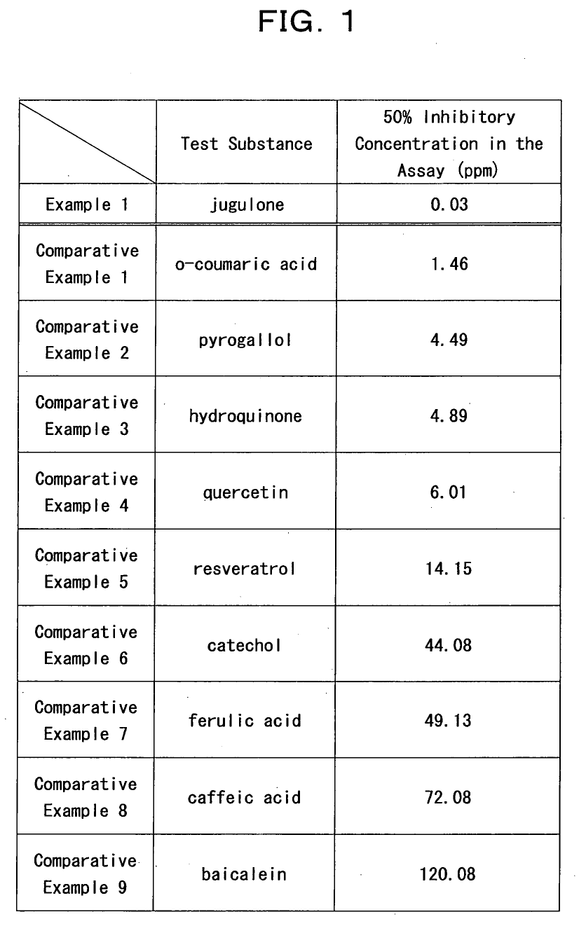

FIG. 1 is a table showing the 50% inhibitory concentrations of juglone of Example 1 and of the phenolic compounds of Comparative Examples 1-9.

As is obvious from FIG. 1, it is seen that the 50% inhibitory concentration of juglone of Example 1 is 0.03 ppm.

Contrary to juglone of Example 1, it is seen that the 50% inhibitory concentrations of the phenolic compounds of Comparative Examples 1-9 are all 1.4 ppm or higher.

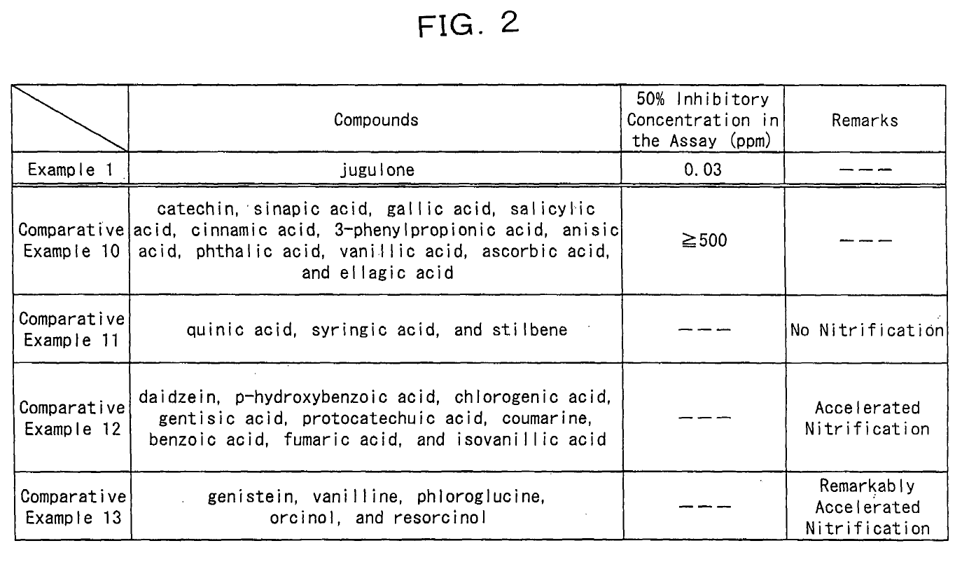

FIG. 2 is a table showing the 50% inhibitory concentrations of juglone of Example 1 and of the compounds of Comparative Examples 10-13.

As is obvious from FIG. 2, it is seen that the 50% inhibitory concentration of the compound of Comparative Example 10 is 500 ppm or higher, hence its nitrification inhibitory function is weak. It is seen that the compound of Comparative Example 11 showed no nitrification inhibitory effect. It is seen that the compound of Comparative Example 12 accelerated nitrification. It is seen that the compound of Comparative Example 13 accelerated nitrification even more than the compound of Comparative Example 12.

From the above, it can be confirmed that, among juglone of Example 1, the phenolic compounds of Comparative Examples 1-9, and the compounds of Comparative Examples 10-13, juglone showed the strongest nitrification inhibitory function.

Next, the concentration dependency of nitrification inhibitory ratio of juglone of Example 1 was further studied, and, from its result, the concentration at which the nitrification inhibitory ratio became 80% (hereinafter, to be properly called as 80% inhibitory concentration) was evaluated. As the result of evaluation, 80% inhibitory concentration of juglone of Example 1 was 0.08 ppm.

On the other hand, 80% inhibitory concentrations of nitrapyrin of Comparative Example 14 was 4 ppm, and 80% inhibitory concentrations of dicyanodiamide of Comparative Example 15 was 185 ppm.

It is seen from this that 80% inhibitory concentration of the nitrification inhibitor of Example 1 was much lower by far than nitrapyrin of Comparative Example 14 and dicyanodiamide of Comparative Example 15 to obtain sufficient nitrification inhibitory function. The fact that the nitrification reaction of nitrification bacteria is prevented by juglone of Example 1 is a novel finding.

As described above, it is seen that the nitrification inhibitor of Example 1 has stronger nitrification inhibitory effect than nitrapyrin or dicyanodiamide as the nitrification inhibitors consisting of conventional synthetic chemicals of Comparative Examples 14 and 15. Also, since the nitrification inhibitor of Example 1 consists of juglone which can be obtained at low price, it can be manufactured at low cost.

### Example 2

As Example 2, a fertilizer composition was prepared consisting of ammonium sulfate as a fertilizing component, juglone as a nitrification inhibitor, and black soil.

The black soil was taken from the surface soil of 0-15 cm depth of the test farm of the Japan International Research Center for Agricultural Sciences in Yawatadai, Tsukuba city, Ibaraki, Japan, and was composed of clay 54.8%, silt 26.3%, and sand 18.9%, and its total carbon content was 30 g/kg, and total nitrogen content was 2.64 g/kg. This black soil was air-dried and homogenized using a sieve of 2 mm to obtain dry black soil (hereinafter, to be properly called dry soil).

The fertilizer of Example 2 was prepared by mixing homogeneously using a mortar with ammonium sulfate by 200 ppmN (here N represents Nitrogen) of added nitrogen per dry soil and juglone by 10 ppm per dry soil.

### Example 3

The fertilizer of Example 3 was prepared similarly to Example 2 except that juglone was mixed with dry soil by 100 ppm of added amount to dry soil.

### Comparative Example 16

The fertilizer of Comparative Example 16 was prepared similarly to Example 2 except that no nitrification inhibitor was added.

### Comparative Example 17

The fertilizer of Comparative Example 17 was prepared similarly to Example 2 except that nitrapyrin was mixed with dry soil by 4.5 ppm of added amount to dry soil.

Next, the nitrification-inhibitory effect of fertilizers was measured for Examples 2 and 3 and Comparative Examples 16 and 17.

As the measurement, the fertilizers of Examples 2 and 3 and Comparative Examples 16 and 17 were put into glass vessels, lids of resin film, for example, of parafilm (brand name) with open needle holes were put thereon, and set into a temperature and moisture-controlled incubator. This incubator was controlled to the temperature of 20° C. and the water saturation in the space among soils of the fertilizer to 60%.

After a certain time, 2 g of the fertilizer was taken out, 20 cm³ of 2 M (mole/1000 cm³) potassium chloride was added, shaken for 2 hours, nitric acid in the fertilizer was extracted, and filtered. The nitrate ion contained in this filtrate was quantitatively measured by using the automatic ion analysis apparatus (Brant+Luebbe, type number AAII).

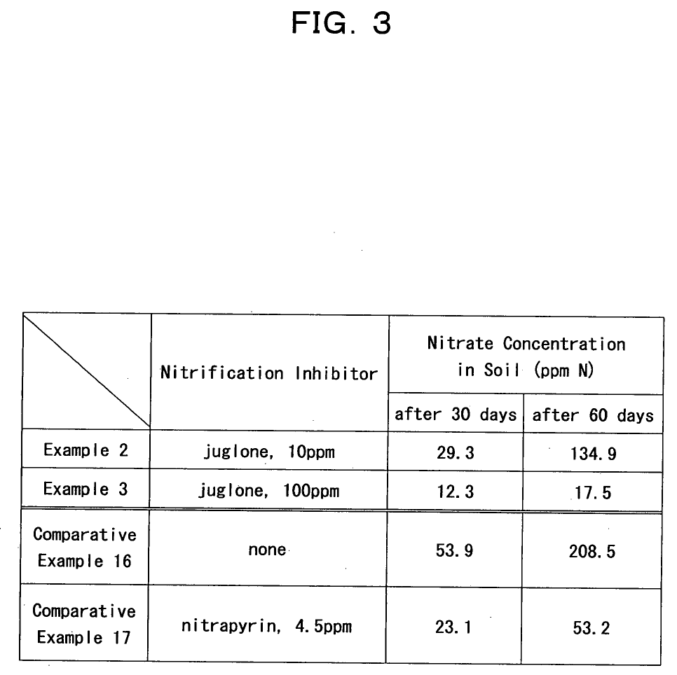

FIG. 3 is a table showing the measurement results of nitrate concentration after 30 days and 60 days for the fertilizers of Examples 2 and 3 and Comparative Examples 16 and 17.

As is obvious from FIG. 3, the nitrate concentrations after 30 days and 60 days for the fertilizer of Example 2 were 29.3 ppmN and 134.9 ppmN, respectively.

The nitrate concentrations after 30 days and 60 days for the fertilizer of Example 3 were 12.3 ppmN and 17.5 ppmN, respectively.

On the other hand, in case of the fertilizer with no nitrification inhibitor added therein of Comparative Example 16, the nitrate concentrations after 30 days and 60 days were 53.9 ppmN and 208.5 ppmN, respectively. This nitrate concentration after 30 days of Comparative Example 16 is about twice or more higher than the nitrate concentrations for the fertilizers containing a nitrification inhibitor of Examples 2 and 3. Further, the nitrate concentration after 60 days of Comparative Example 14 was about four times that after 30 days.

In case of the fertilizer of Comparative Example 17, the nitrate concentrations after 30 days and 60 days were 23.1 ppmN and 53.2 ppmN, respectively.

From the above, the fertilizer containing juglone of Examples 2 and 3 inhibits nitrification effectively in the soil, and its effect equals to the fertilizer containing nitrapyrin of Comparative Example 17.

As is mentioned above, it is seen that the fertilizer of Examples 2 and 3 inhibits nitrification effectively, and its nitrification inhibitory effect equals to the fertilizer containing nitrapyrin as the conventional nitrification inhibitor. Also, since the fertilizer of Examples 2 and 3 contains juglone which can be obtained at low price as a nitrification inhibitor, the fertilizer of Examples 2 and 3 can be manufactured at low cost. Furthermore, since the fertilizer of Examples 2 and 3 contains non-volatile and chemically stable juglone as a nitrification inhibitor, the fertilizer of Examples 2 and 3 has nitrification inhibitory effect about equal to the fertilizer containing a conventional nitrification inhibitor, and can maintain for long time its nitrification inhibitory effect.

The present invention is in no way limited only to the forms of the embodiments mentioned above, but appropriate variations are possible within the range of the present invention recited in the claims, and needless to say that these are also included within the range of the present invention. For example, the compositions of soil improvers and fertilizers containing the nitrification inhibitor of the present invention may be properly designed according to agricultural products and flowers to be grown, and needless to say that it is not limited to the examples mentioned above.

What is claimed is:

1. A nitrification inhibitor, wherein juglone constitutes a main component to inhibit nitrification of soil.

2. A soil improver containing a nitrification inhibitor consisting of juglone.

3. The soil improver as set forth in claim 2, wherein said nitrification inhibitor is contained in the range of 20 to 50 weight %.

4. A fertilizer containing a nitrification inhibitor consisting of juglone.

5. The fertilizer as set forth in claim 4, wherein said nitrification inhibitor is contained in the range of 20 to 50 weight %.
